(19) United States
(12) Patent Application Publication
(10) Pub. No.: US 2025/0153876 A1
(43) Pub. Date: May 15, 2025

(54) APPARATUS AND METHOD FOR PRODUCING CONTAINER BUNDLES

(71) Applicant: Krones AG, Neutraubling (DE)

(72) Inventors: Christian PAUL, Pentling (DE); Thomas ALBRECHT, Beilngries (DE); Heinz HENNEK, Neutraubling (DE)

(21) Appl. No.: 18/945,074

(22) Filed: Nov. 12, 2024

(30) Foreign Application Priority Data
Nov. 13, 2023 (DE) 10 2023 131 511.0

(51) Int. Cl. B65B 35/36; B25J 11/00; B65B 13/00; B65B 39/00; B65B 57/14

(52) U.S. Cl. CPC B65B 35/36; B25J 11/00; B65B 13/00; B65B 39/00; B65B 57/14

(57) ABSTRACT

The present disclosure relates to an apparatus for producing container bundles, comprising a container inlet for transporting containers that contain product, an inspection apparatus for individually detecting the containers, wherein the inspection apparatus is configured, based upon the detected containers, to output a detection signal, a packer inlet with one or more inlet lanes, a robot that is configured to move the containers, entering via the container inlet, to the one or more inlet lanes of the packer inlet on the basis of the detection signal and a control signal, and a packer that is configured to produce, on the basis of a predetermined pattern, a container bundle, comprising a plurality of containers, from the containers guided on the packer inlet.

### CROSS REFERENCE TO RELATED APPLICATION

The present application claims priority to German Patent Application No. 10 2023 131 511.0 filed on Nov. 13, 2023. The entire contents of the above-listed application are hereby incorporated by reference for all purposes.

### TECHNICAL FIELD

The present disclosure relates to an apparatus for producing container bundles and an associated method for producing container bundles, in particular using said apparatus.

### BACKGROUND

Typical apparatuses for producing container bundles (for example, in the beverage industry) produce a product rigidly, so that the bundles consist of a plurality of containers with the same product. In order to be able to fill a new product, the apparatus usually has to be stopped, retooled, and provided with new type parameters. Even if some modern filling valves for product filling are capable of filling a different product per filling round, a major limiting factor for multi-product filling within a line is the lack of a structured allocation of the containers filled with different products into the bundles. A controlled and efficient production of bundles with different products is hardly possible in this way. WO 2009/153080 A1 discloses an apparatus and a method for assembling bundles for a packaging machine.

### SUMMARY

In view of these stated disadvantages, an aim of this disclosure is to improve the efficiency of multi-product filling. This results in a more efficient production of container bundles, which can in particular contain different types of product according to a predetermined pattern. This object is achieved by the apparatus and the method as described herein.

According to the disclosure, the apparatus comprises a container inlet for transporting containers that contain product, an inspection apparatus for individually detecting the containers, wherein the inspection apparatus is configured, based upon the detected containers, to output a detection signal, a packer inlet with one or more inlet lanes, a robot that is configured to move the containers, entering via the container inlet, to the one or more inlet lanes of the packer inlet on the basis of the detection signal and a control signal, and a packer that is configured to produce, on the basis of a predetermined pattern, a container bundle comprising a plurality of containers from the containers guided on the packer inlet, wherein the robot is arranged between the container inlet and the packer inlet, and wherein the packer generates the control signal for the robot, which indicates which containers are required on which inlet lane of the packer inlet.

The robot places the individual containers, which are to be processed into a bundle by the packer, onto the inlet lanes of the packer inlet, so that the individual containers only need to be grouped into a bundle. It is not necessary to re-sort or realign the containers to produce the bundles. For this purpose, the packer provides the robot with a control signal that indicates which containers are required on which inlet lane of the packer inlet. Based upon the control signal, the robot fills the inlet lanes with the containers from the container inlet. It is therefore possible to combine any combination of containers into a bundle according to a given pattern without providing complex filling lines with lane conveyors or similar apparatuses. This improves the efficiency in bundle production, especially when different types of product are to be combined in one bundle in a multi-product filling process.

The containers provided on the container inlet each contain a product—for example, one of different drinks such as lemonade, water, juice, etc. The containers can contain different products from one another, i.e., there can be containers with lemonade, water, and/or juice on the container inlet.

The inspection apparatus is configured to individually detect the containers on the container inlet. The inspection apparatus detects in particular which product the individual container is filled with. For this purpose, the inspection apparatus can, for example, comprise a light barrier for the container inlet, which detects the number of containers and/or the product in the individual containers. The latter can be done, for example, using a specific identifier on the container (e.g., barcode, QR code, etc.), wherein the identifier can be assigned to a specific type of product. Furthermore, the inspection apparatus generates a detection signal and transmits it to the robot. The detection signal contains information about where containers with a certain type of product are present in the container inlet and/or how many containers with a certain type of product are present.

In this description, a robot refers to an apparatus that is configured to transport one or more containers by mechanical means—for example, by moving or lifting. The robot is controlled by an internal or external control device, such as a computer. The control device provides an algorithm for controlling the robot. In particular, the control device receives the control signal from the packer and calculates on this basis how the incoming containers must be moved from the container inlet to the one or more lanes of the packer inlet. Based upon this information, an algorithm controls the function of the robot, in particular the pattern according to which the incoming containers must be moved in order to achieve the desired loading on the packer inlet. In addition, the robot receives information from the detection signal about where the required containers are located in the container inlet. In summary, the robot thus receives information from the detection signal about where on the container inlet a certain container is to be picked up and where this container is to be delivered on the packer inlet. In particular, the control of the robot can be automated. Likewise, an operator of the apparatus can manually access the robot's control.

The robot can be a tripod robot, especially with delta kinematics, or an articulated-arm robot with up to six degrees of freedom. These types of robots are already used in the beverage industry to process container bundles. It is crucial here that the robot have suitable kinematics to be able to transport/move the containers at sufficient speed. In cooperation with the apparatus described here, these robots thus allow a high performance capacity in a container transport environment.

The robot can have a gripping tool to grip one or more containers at the same time. In principle, the gripping tool can be configured to simply move the container(s) or to lift the container(s) for transport.

The packer inlet has one or more inlet lanes to the packer. On several lanes, the containers can be arranged next to each other and behind each other during transport along a transport direction.

The packer is configured to produce bundles, each containing a plurality of containers, from the containers from the packer inlet. For this purpose, the packer receives information about which bundles are to be produced, i.e., the number of containers per bundle and which product types in what quantity shall be present in the bundle (=pattern for bundle production). Based upon this pattern, the robot is instructed, via a control signal generated and output by the packer, to load the packer inlet in such a way that the containers with the required type of product are already placed accordingly on the packer inlet so that the containers can be grouped directly into a bundle. This increases efficiency in bundle production because the required containers are directly available to the packer, and no re-sorting or waiting for correct containers is necessary. In addition, the pattern for bundle production can also be changed on short notice without the need to retool the apparatus, because the new pattern can be passed on to the robot in the form of a new control signal. The flexibility of the apparatus can also thereby be improved.

The inspection apparatus can further be configured to identify damaged, incorrectly printed, and/or incorrectly filled containers. The apparatus can further be configured to sort out containers identified as damaged, incorrectly printed, and/or incorrectly filled.

Ensuring that only flawless containers are used for bundle production increases the reliability of the apparatus described. In addition, the apparatus can be configured to be more compact by having the inspection apparatus perform multiple tasks and eliminating the need for an additional inspector to check the containers.

The apparatus can further comprise a buffer zone for receiving containers. In this case, the robot is configured to move containers that are not needed for bundle production into the buffer zone.

Unused containers that remain on the container inlet can lead to operational disruptions if they cause congestion in the inlet, tip over, or otherwise impede the container flow. By moving them to a buffer area, the containers that are not needed are removed from the container inlet, thus reducing the risk of operational disruption.

The containers in the buffer zone can be transportable into the container inlet. In other words, the apparatus can be configured to transport containers from the buffer zone back to the container inlet.

Containers that are temporarily not needed may be needed again at a later date—for example, if other bundles are to be produced. The containers from the buffer zone are therefore returned to the production process and can be received in bundles. It is therefore not necessary to fill new containers for bundle production, which saves upon resources.

The container bundle produced by the apparatus can comprise containers with at least two different types of product. The apparatus can therefore be configured to produce container bundles comprising at least two different types of product.

The structural features of such an apparatus have already been described above. The possibility of filling several product types increases the flexibility in bundle production compared to the situation when bundles can be produced with only one type of product.

The container inlet can be a bulk inlet, a single-lane inlet, or a multi-lane inlet.

In essence, the apparatus is compatible with different embodiments of the container inlet and is therefore very flexible. For each of the above-mentioned inlet forms, the robot can move the incoming containers to one or more inlet lanes of the packer. A mass inlet is an easy-to-implement form of transporter and therefore represents the most efficient implementation. For example, it is not necessary to pre-sort the containers according to product type. This saves upon further expensive resources.

The apparatus can comprise one or more robots, so that the apparatus comprises two or more robots in total. The further robot(s) can be arranged between the container inlet and the packer inlet, wherein the robot and the further robot(s) are configured as a robot unit, and wherein the robot unit is configured to displace the containers, entering via the container inlet, onto the one or more inlet lanes of the packer inlet on the basis of the detection signal and a control signal.

The robot and the further robot(s) can be arranged next to each other or one behind the other, as seen from the container inlet.

The two or more robots can be controlled by the same control device. There may also be a common algorithm to control the two or more robots together. The work performed by the two or more robots can be coordinated in different ways. For example, the robot can serve one or more sections of the container inlet and move the incoming containers in these sections to the inlet lanes of the packer inlet. The additional robot or robots takes/take over the remaining sections of the container inlet that are not served by the first robot and in turn carries/carry out the movement of the containers entering the remaining sections. Thus, the entire container inlet is operated by the robot unit. Because each of the two or more robots serves only one section of the container inlet, an overall higher throughput can be achieved with this robot unit than with a single robot, because the two or more robots work in parallel, and the capacities of the individual robots practically add up.

Alternatively, the two or more robots can complement each other in other ways as well. The robot can be configured to operate the container inlet and create an intermediate distribution of the incoming containers. This intermediate distribution is taken over by the other robot(s) and processed into a specific distribution of outgoing containers in the packer inlet. The other robot(s) can serve all inlet lanes. In this case too, a higher throughput can be achieved compared to a single robot if the generation of the intermediate distribution requires less time or fewer work steps than the generation of the distribution of the outgoing containers.

It is also possible for the two or more robots to serve the same section of the container inlet alternately or in an irregular order. The robot does not serve one or more sections for a time, which are then served by the other robot(s). In this way, the two or more robots that process the sections in parallel complement each other, and a higher throughput can be achieved than with a single robot.

Overall, by using the additional robot(s), it is possible to increase the performance capacity of the apparatus, i.e., the throughput of containers, by having the incoming containers processed simultaneously by several robots.

The specifications provided above regarding the structural embodiment of the robot can also apply to the other robot(s). In particular, each of the other robots can have a gripping tool in order to be able to grip one or more containers simultaneously. The additional robot(s) can be a tripod robot, in particular with delta kinematics, or an articulated-arm robot with up to six degrees of freedom.

The apparatus can further comprise a filler, upstream of the container inlet, for filling product into the containers, wherein the filler is configured to fill two or more different types of product.

By using a filler that can fill several different types of product without the need to retool the apparatus, the flexibility of the entire apparatus is increased, especially because, for example, no downtime is necessary for retooling if containers with several different types of product are required for bundle production.

The robot and/or the packer can be further configured to output a filling signal to the filler defining which type of product is to be filled by the filler, wherein the filler fills a product into one of the containers based upon the filling signal.

The filling signal contains information about which product types are (primarily) required for bundle production. This allows the filler to fill the containers with the types of products that are needed, thus avoiding the need to fill any unnecessary containers. This saves upon resources and time compared to filling without coordination between packer, robot, and filler.

In addition, the present disclosure provides a method for producing container bundles. The method comprises providing containers containing product on a container inlet, detecting the containers and outputting a detection signal based upon the detected containers, distributing the containers, on the basis of the detection signal and a control signal, to one or more inlet lanes of a packer inlet, and producing a container bundle from a plurality of containers, on the basis of a predetermined pattern, from the containers guided on the packer inlet, wherein the distribution of the containers to the one or more inlet lanes of the packer inlet takes place on the basis of a control signal which indicates which containers are required on which inlet lane of the packer inlet.

For the reasons previously mentioned in conjunction with the described apparatus, this method allows an efficient production of container bundles which can in particular contain different types of product according to a predetermined pattern.

The method can further comprise identifying damaged, incorrectly printed, and/or incorrectly filled containers. In particular, damaged, incorrectly printed, and/or incorrectly filled containers can be sorted out.

Ensuring that only flawless containers are used for bundle production increases the reliability of the method described. In addition, the method can be made more efficient by eliminating the need for an additional inspection step to check the containers.

Furthermore, containers that are not required for bundle production can be transported to a buffer zone.

Unneeded containers that remain on the container inlet can lead to operational disruptions if they cause congestion in the inlet, tip over, or otherwise impede the container flow. By moving them to a buffer area, the containers that are not needed are removed from the container inlet, thus reducing the risk of operational disruption.

The containers can be transported from the buffer zone to the container inlet.

Containers that are temporarily not needed may be needed again at a later date—for example, if other bundles are to be produced. The containers from the buffer zone are therefore returned to the production process and can be received in bundles. It is therefore not necessary to fill new containers for bundle production, which saves upon resources.

The method can further comprise upstream filling of product into the containers with a filler, wherein the filler is configured to fill two or more types of different product, wherein the filler receives a filling signal which defines which type of product is to be filled by the filler, and wherein the filler fills a product into one of the containers, in particular on the basis of the filling signal.

The filling signal contains information about which product types are (primarily) required for bundle production. This allows the filler to fill the containers with the types of products that are needed, thus avoiding the need to fill any unnecessary containers. This saves upon resources and time compared to filling without prior coordination of the required product types.

The described method can be carried out with the described apparatus.

### BRIEF DESCRIPTION OF THE FIGURES

Further features and advantages are explained below with reference to the exemplary figures, in which:

FIG. 1 shows a schematic plan view of an apparatus for producing container bundles according to a first embodiment,

FIG. 2 shows a schematic plan view of an apparatus for producing container bundles according to a second embodiment, and

FIG. 3 shows a schematic plan view of an apparatus for producing container bundles according to a third embodiment.

### DETAILED DESCRIPTION

In the following and in the figures, the same reference signs are used for identical or corresponding elements in the different exemplary embodiments, unless otherwise specified.

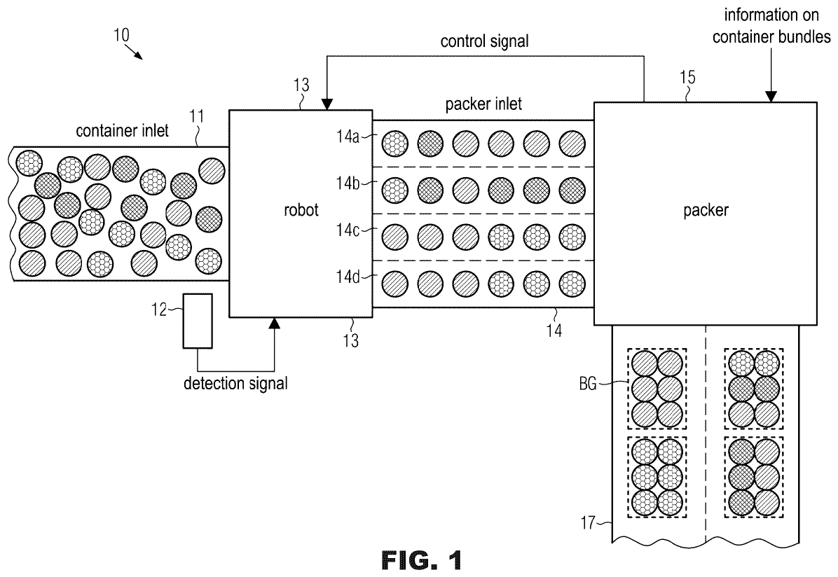

FIG. 1 shows a schematic plan view of an apparatus 10 for producing container bundles according to a first embodiment. The apparatus 10 comprises a container inlet 11, on which a plurality of containers are transported in a predetermined direction towards a robot 13. The container inlet 11 is configured in the form of a mass transport on which the containers are transported in an unordered manner. A conveyor belt, for example, serves as the container inlet 11.

In principle, it is also possible to choose another form of transport with one or more lanes for the container inlet 11. An advantage of lane transport is its ease of handling and implementation compared to a single- or multi-lane inlet. Furthermore, the containers on the container inlet are filled with different types of products, which is shown by the different hatching. The containers are not sorted according to the product they contain. The product can include different drinks, such as water, juice, juice spritzer, lemonade, milk drinks, beer, or spirits. Other substances such as cocoa powder, coffee beans, or detergent are also conceivable. In this example, three different products are shown (different hatching), but this should not be understood as limiting.

An inspection apparatus 12 is arranged on the container inlet 11 and detects the containers passing by on the container inlet 11. The inspection apparatus 12 primarily detects which type of product is contained in the containers. This can be achieved, for example, by encoding on the container (QR code, barcode, batch number, etc.) or optical properties of the product. The inspection apparatus 12 then generates a detection signal which defines at which point in the container inlet 11 which containers with which product type are present. This detection signal is transmitted to the robot 13. The inspection apparatus 12 can optionally be configured to identify damaged, incorrectly filled, and/or incorrectly printed containers. These containers can be sorted out using an appropriate device.

The containers are fed to the robot 13 from the container inlet 11. The robot's task is to move the incoming containers to a packer inlet 14 according to a specific pattern. For this purpose, the robot receives a control signal, the function of which is described in greater detail below. The robot 13 itself is shown only schematically in this figure; it can also be a robot unit consisting of the robot 13 and at least one other robot. The robot 13 is, for example, a tripod robot with a gripping tool that is configured to grip and lift or move one or more containers. Tripod robots offer a high degree of spatial flexibility and are therefore able to serve a large number of inlet lanes while maintaining a compact form. In addition, they allow high-speed control with high precision and are therefore well suited for the described use in a distribution apparatus in which a high throughput of containers is to be achieved.

The packer inlet 14 is a conveying device, such as a conveyor belt, and comprises one or more lanes that feed the containers to a packer 15. In the example shown, there are four lanes 14a, 14b, 14c, 14d, but this should not be understood as a limiting example. The robot 13 is configured to move the containers, entering via the container inlet 11, to the inlet lanes 14a, 14b, 14c, 14d of the packer inlet 14.

The packer 15 receives the containers from the packer inlet 14 and produces container bundles BG from them. The container bundles BG can be formed directly from adjacent, incoming containers from the packer inlet 14. This eliminates the need to move and re-sort containers, making the method simple and efficient. This relationship is also shown in the figure, as to how the containers are converted into container bundles BG on the packer inlet 14. The container bundles BG can include different numbers of containers and combinations of the three available product types. This means that bundles (six-packs) can be produced with just one type of product, but also bundles with two or three types of product, each present in equal proportions. However, it goes without saying that in principle any number of containers and combinations of product types in the bundles can be realized. The produced container bundles BG are transported further via an outlet 17—for example, to a packaging machine (not shown).

The packer 15 receives the information about which container bundles BG are to be produced. This information defines a predefined pattern for bundle production and can, for example, be entered by a user via an interface. From this information, the packer generates a control signal that indicates which containers are required on which inlet lane 14a, 14b, 14c, 14d of the packer inlet 14. Based upon this control signal, the robot 13 loads the inlet lanes 14a, 14b, 14c, 14d, so that the container bundles BG can be produced as described.

The described apparatus 10 allows a production of container bundles BG from a mass feed of containers with a plurality of product types. It is not necessary to separate the different product types into lanes beforehand or to pre-sort the containers before bundle production. The cooperation of the components shown results in efficient bundle production and a compact embodiment of the apparatus 10, in particular for the production of bundles with a plurality of product types.

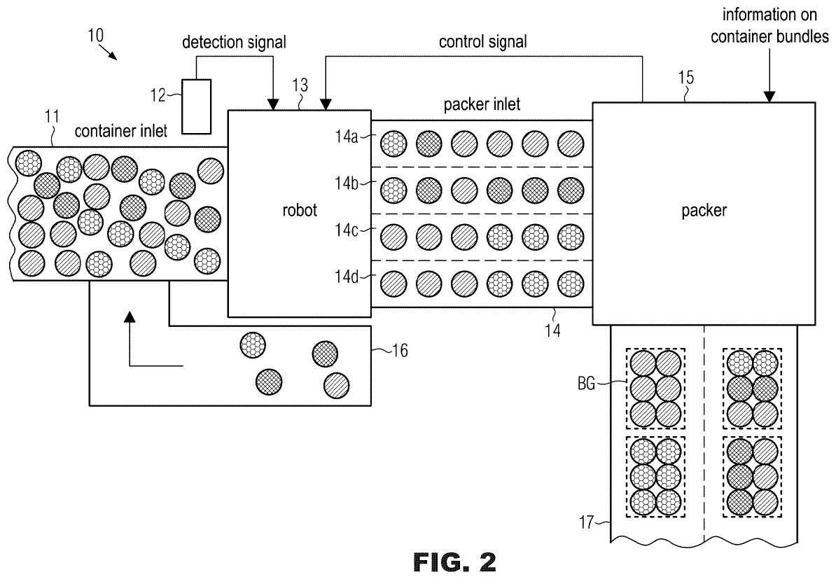

FIG. 2 shows a schematic plan view of an apparatus 10 for producing container bundles according to a second embodiment. Some elements correspond to those of the first embodiment, so they will not be discussed in detail below.

The second embodiment differs in the presence of a buffer zone 16, which serves to temporarily store containers not required for the bundle production. The buffer zone 16 is located near or adjacent to the robot 13 so that the robot 13 can transport containers from the container inlet 11 to the buffer zone 16. The buffer zone 16 can be an area on which the containers are placed. However, the buffer zone can also be a conveying device, as in the example shown, by which the containers can be returned to the container inlet (shown by the arrow).

The containers shown on the container inlet 11 contain the containers required for bundle production, i.e., those which are transferred by the robot 13 to the packer inlet 14, as well as four additional containers. These additional containers are recognized as superfluous by the robot 13 using the detection signal and the control signal, and are moved to the buffer zone 16. Otherwise, these containers could remain in the container inlet 11 and lead to congestion or other operational disruptions. The containers in the buffer zone 16 are transported back to the container inlet 11 and can be used at a later time for bundle production. This means that no new containers need to be filled, thus saving upon resources.

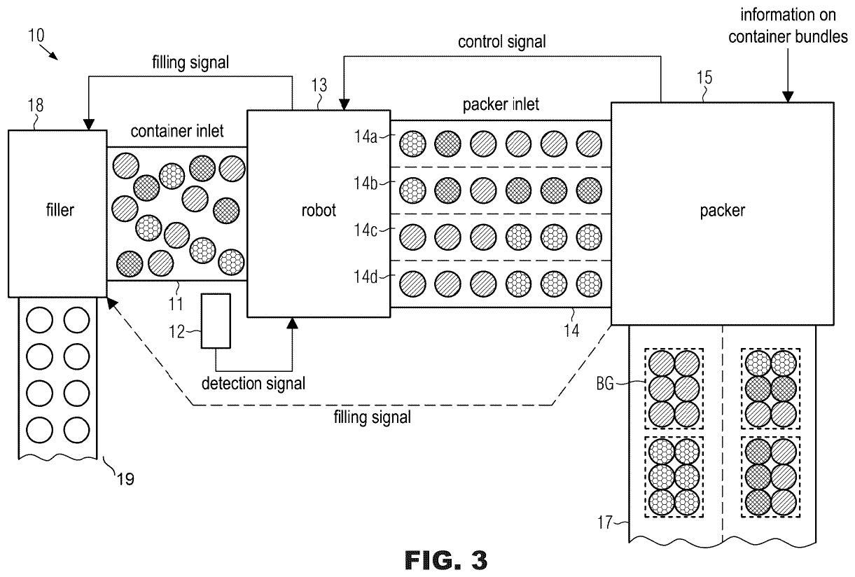

FIG. 3 shows a schematic plan view of an apparatus 10 for producing container bundles according to a third embodiment. Some elements correspond to those of the first or second embodiment, so they will not be discussed in detail below.

The apparatus 10 of the third embodiment differs from that of the first embodiment primarily by a filler 18, upstream of the container inlet, for filling product into the containers. In addition, the apparatus 10 comprises an inlet 19 which transports empty containers to the filler 18.

The filler 18 is configured to fill different types of products into the empty containers (one product per container, but the set of filled containers includes containers with different fillings). For this purpose, the filler can, for example, have a valve with a plurality of product-carrying lines. A different product can be filled in each filling round. Of course, the filler 18 can have several such valves in order to fill several containers simultaneously.

The filler 18 receives a filling signal that defines which type of product is to be filled. This filling signal is primarily generated by the robot 13 and transmitted to the filler 18. As already explained, the packer 15 has the information about which bundles are to be produced and which containers are required for this purpose. This information is transmitted in the form of a control signal to the robot 13, which accordingly fills the inlet lanes 14, 14b, 14c, 14d of the packer inlet 14 with containers containing the appropriate product type, using the detection signal. The robot uses the detection signal to detect the need for certain types of product and, in the event of an oversupply or shortage of a particular product, can instruct the filler 18 to fill less or more of the respective product, using the filling signal.

Alternatively, the packer 15 can also be configured to generate such a filling signal and transmit it to the filler 18 (dashed line). Based upon the information about the required containers, the filler 18 is instructed via the filling signal to fill the required product types.

The described embodiments of the apparatus 10 can be used accordingly to carry out the method described above.

In both cases, the filler is controlled upstream of the production line. Starting from the packer 15, which receives the information about which bundles are to be produced, the robot 13 is controlled in order to correctly load the inlet lanes 14, 14b, 14c, 14d of the packer inlet 14 so that the bundles can be formed directly from them. Through the upstream inspection with the inspection apparatus 12, the robot recognizes which containers and product types are available in the container inlet 11. The robot then generates a filling signal to instruct the filler 18 to fill appropriate quantities of a particular type to meet the demand for that particular product type. Analogously, the filling signal can be transmitted directly from the packer 15 to the filler 18, bypassing the robot 13. The apparatus and the implementable method enable efficient bundle production, even when several product types are present in one bundle, or different bundle combinations are to be produced within a short period of time. In addition, resources are saved upon because few excess containers are produced, by specifically instructing the filler 18 to fill the required product type via the filling signal.

It is understood that the individual shown embodiments can also be combined with each other in a suitable manner. For example, it is possible to have an apparatus with a buffer zone and a filler (combination of the second and third exemplary embodiments).

1. An apparatus for producing container bundles, comprising:
a container inlet for transporting containers containing product,
an inspection apparatus for individually detecting the containers, wherein the inspection apparatus is configured, based upon the detected containers, to output a detection signal,
a packer inlet with one or more inlet lanes,
a robot which is configured to move the containers, entering via the container inlet, to the one or more inlet lanes of the packer inlet on the basis of the detection signal and a control signal, and
a packer which is configured to produce, on the basis of a predetermined pattern, a container bundle comprising a plurality of containers from the containers guided on the packer inlet,
wherein the robot is arranged between the container inlet and the packer inlet, and
wherein the packer generates the control signal for the robot, which indicates which containers are required on which inlet lane of the packer inlet.

2. The apparatus according to claim 1, wherein the inspection apparatus is further configured to identify damaged, incorrectly printed, and/or incorrectly filled containers.

3. The apparatus according to claim 1, further comprising a buffer zone for receiving containers,
wherein the robot is configured to move containers that are not required for the bundle production into the buffer zone.

4. The apparatus according to claim 3, wherein containers can be transported from the buffer zone into the container inlet.

5. The apparatus according to claim 1, wherein the container bundle comprises containers with at least two different types of product.

6. The apparatus according to claim 1, wherein the container inlet is a mass inlet, a single-lane inlet, or a multi-lane inlet.

7. The apparatus according to claim 1, further comprising one or more further robots,
wherein the further robot(s) is/are arranged between the container inlet and the packer inlet,
wherein the robot and the further robot(s) are configured as a robot unit, and
wherein the robot unit is configured to move the containers, entering via the container inlet, to the one or more inlet lanes of the packer inlet on the basis of the detection signal and a control signal.

8. The apparatus according to claim 1, further comprising a filler, upstream of the container inlet, for filling product into the containers,
wherein the filler is configured to fill two or more different types of product.

9. The apparatus according to claim 8, wherein the robot and/or the packer is/are further configured to output a filling signal to the filler which defines which type of product is to be filled by the filler, and
wherein the filler fills a product into one of the containers based upon the filling signal.

10. A method for producing container bundles, comprising the steps of:
providing containers containing product on a container inlet,
detecting the containers and outputting a detection signal based upon the detected containers,
distributing the containers, on the basis of the detection signal and a control signal, to one or more inlet lanes of a packer inlet, and
producing a container bundle from a plurality of containers, on the basis of a predetermined pattern, from the containers guided on the packer inlet,
wherein the distribution of the containers to the one or more inlet lanes of the packer inlet is carried out on the basis of a control signal which indicates which containers are required on which inlet lane of the packer inlet.

11. The method according to claim 10, further comprising the step of:
identifying damaged, incorrectly printed, and/or incorrectly filled containers.

12. The method according to claim 10, further comprising the step of:
transporting containers that are not required for bundle production to a buffer zone.

13. The method according to claim 12, wherein the containers are transported from the buffer zone into the container inlet.

14. The method according to claim 10, further comprising the step of:
upstream filling of product into the containers with a filler,
wherein the filler is configured to fill two or more types of different product,
wherein the filler receives a filling signal which defines which type of product is to be filled by the filler, and
wherein the filler fills a product into one of the containers.

15. The method according to claim 14, wherein the filler fills a product into the containers on the basis of the filling signal.

16. The method according to claim 11, wherein the method further comprises sorting out these containers.
